(19) United States
(12) Patent Application Publication
(10) Pub. No.: US 2006/0276165 A1
(43) Pub. Date: Dec. 7, 2006

(54) Dual mode communication system and method

(76) Inventor: Hidekazu Nakama, San Diego, CA (US)

Correspondence Address: Benman, Brown & Williams, Suite 2740, 2049 Century Park East, Los Angeles, CA, 90067, US

(21) Appl. No.: 11/141,819

(22) Filed: Jun. 1, 2005

(51) Int. Cl. H04Q 7/20

(52) U.S. Cl. 455/403

(57) ABSTRACT

A communication system including a first transceiver adapted to communicate with a first network; a second transceiver adapted to communicate with a second network; and an interface to a third network a switching network is included for routing signals between the first transceiver and the interface in a first mode of operation and for routing signals between the first transceiver and the second transceiver in a second mode of operation. A central processing unit is included for switching the controller between the first mode and the second mode in response to an input signal. In the illustrative embodiment, the first network is a cordless telephone network, the second network is a wireless cellular network and the third network is a public switched telephone network. In the illustrative application, the inventive system is implemented as a dual mode base station adapted for routing signals between a cordless transceiver and a public switched telephone network in a first mode of operation and routing signals between said cordless transceiver and a wireless cellular network in a second mode of operation. In the illustrative embodiment, the inventive dual mode base station includes a cordless transceiver; a wireless transceiver; an interface to a public switched telephone network; a switching network for routing signals between said cordless transceiver and said interface in a first mode of operation and between said cordless transceiver and said wireless transceiver in a second mode of operation; and a central processing unit for switching the controller between the first mode and the second mode in response to an input signal.

### BACKGROUND OF THE INVENTION

1. Field of the Invention

The present invention relates to communications systems. More specifically, the present invention relates to systems and techniques for providing dual mode operation for telephone systems.

2. Description of the Related Art

Consumers today have many options with respect to their telephone equipment options. A typical consumer may have one or more wired or cordless telephones in the home or office and a wireless or cellular telephone for use away from home. As wired phones limit the movement of the user, cordless and wireless telephones are being used increasingly in the home. Cordless telephones are similar to conventional corded telephones in that they are connected by wire to a local central office. But, they differ in that there is no cord between the base unit of the cordless telephone and the handset. Cordless telephones add the convenience of mobility within the range of coverage of the cordless telephone.

The deployment of cellular service established the beginning of a wireless telephony era. The first widely adopted and implemented standard in the United States was AMPS cellular. Later, other standards were implemented, including TDMA (IS-136), CDMA (IS-95), GSM, PCS (various standards), and others. All of these wireless telephones share the characteristic that there is no local metallic loop employed to render service. Rather, a wireless telephone network is deployed by a service provider and wide area coverage is delivered via radio signals.

However, wireless telephones are physically small and the user interface is rather compact. This reduces the convenience of operation. The transmitter power and received signal strengths are very low, due to the battery power limitations and network infrastructure considerations. This means that radio signal strength is often so limited that interference and noise become common annoyances during calls. The mobility of the receiver exacerbates this because of the vagaries of radio propagation, including multi-path interference, Rayleigh fading, and physical blocking of radio signal paths. In addition, wireless telephones have limited battery life, especially during extended conversation times.

Cordless telephones offer improved interfaces and performance over wireless telephones in most circumstances. They are usually larger and have more complete and convenient user interfaces. The base unit can house voice messaging systems and speakerphones. They operate in a small geographic area so that signal levels at the receivers of both the base and handset are higher, offering higher signal to noise ratios, and generally less interference. They also offer longer battery life standby and talk times, due to larger batteries and more extended times at rest on a charging cradle.

A number of dual mode phones have been developed to offer the convenience of a cordless telephone for use in the home and the benefits of a wireless telephone for use elsewhere. These systems generally use a dual mode handset having both a wireless and a cordless transceiver. However, these handsets are generally bulky and expensive.

Hence, there is a need in the art for a system or method for allowing a user to exploit the benefits of wireless and wired telephone service via an easy to use, inexpensive and preferably cordless handset.

### SUMMARY OF THE INVENTION

The need in the art is addressed by the communication system of the present invention. In a general embodiment, the inventive system includes a first transceiver adapted to communicate with a first network; a second transceiver adapted to communicate with a second network; and an interface to a third network. A switching network is included for routing signals between the first transceiver and the interface in a first mode of operation and for routing signals between the first transceiver and the second transceiver in a second mode of operation. A central processing unit is included for causing the switching network to switch between the first mode and the second mode in response to an input signal.

In the illustrative embodiment, the first network is a cordless telephone network, the second network is a wireless cellular network and the third network is a public switched telephone network.

In the illustrative application, the inventive system is implemented as a dual mode base station adapted for routing signals between a cordless transceiver and a public switched telephone network in a first mode of operation and routing signals between said cordless transceiver and a wireless cellular network in a second mode of operation.

In the illustrative embodiment, the inventive dual mode base station includes a cordless transceiver; a wireless transceiver; an interface to a public switched telephone network; a switching network for routing signals between said cordless transceiver and said interface in a first mode of operation and between said cordless transceiver and said wireless transceiver in a second mode of operation; and a central processing unit for switching the controller between the first mode and the second mode in response to an input signal.

### BRIEF DESCRIPTION OF THE DRAWINGS

FIG. 1A is a block diagram showing a dual mode base station in accordance with an illustrative implementation of the present invention.

FIG. 1B is a block diagram showing a dual mode handset in accordance with an illustrative implementation of the present invention.

FIG. 2 is a more detailed diagram of the base station of FIG. 1A.

FIG. 3 is a logic table showing switch settings effected by the central processing unit of the base station of FIG. 1A for operation in accordance with an illustrative two-line embodiment of the present invention.

FIG. 4 is a logic table showing switch settings effected by the central processing unit of the base station of FIG. 1A for operation in accordance with an alternative cellular only mode of operation.

FIG. 5 is a flow diagram of an illustrative embodiment of a method implemented in software and executed by the CPU of the inventive base station in accordance with the present teachings.

### DESCRIPTION OF THE INVENTION

Illustrative embodiments and exemplary applications will now be described with reference to the accompanying drawings to disclose the advantageous teachings of the present invention.

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope thereof and additional fields in which the present invention would be of significant utility.

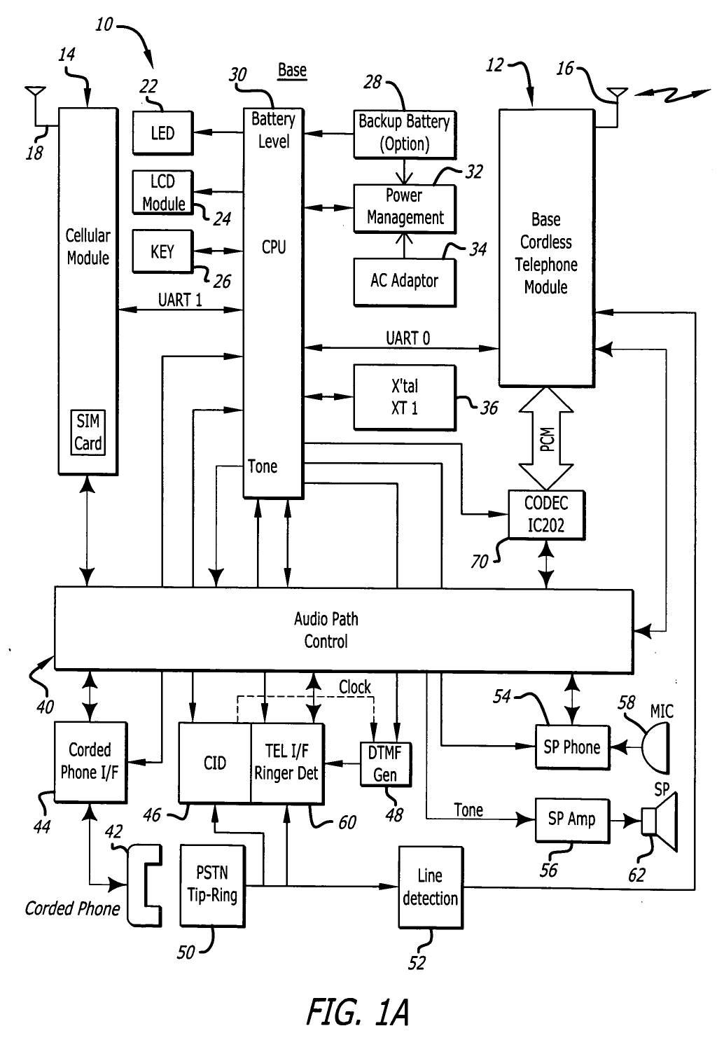

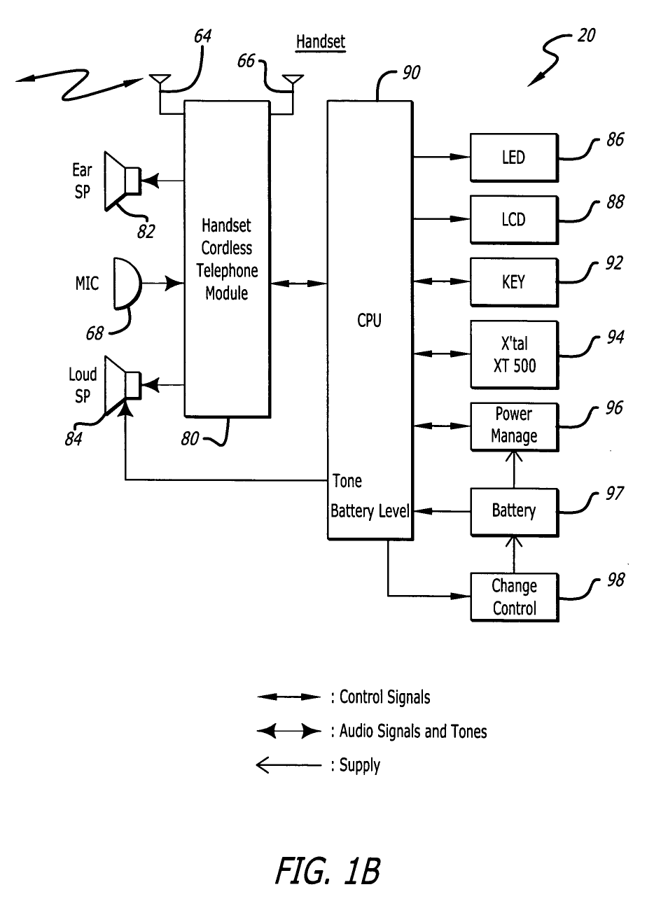

FIG. 1A is a block diagram showing a dual mode base station in accordance with an illustrative implementation of the present invention. In accordance with the present teachings, the system 10, 20 is able to connect to both the PSTN and cellular lines simultaneously and conference both lines. The system 10, 20 consists of three units: a base 10, a cordless handset 20 and a charger (not shown). The base station 10 includes a cordless telephone transceiver module 12 and a cellular module 14. The cordless module 12 communicates with one or more cordless handset units 20 via an antenna 16. In the illustrative embodiment, the cordless modules communicate at 2.4 GHz with a frequency hopping scheme. The cellular module communicates with a cellular network via a second antenna 18. In the best mode, the antenna 18 is a dual band antenna operative in the GSM and CDMA frequency ranges.

In accordance with the present teachings, the base station 10 routes communication signals between the cordless transceiver module 12, the cellular module 14 and a wired network such as a PSTN (public switched telephone network) via a PSTN interface 50. This is effectuated by a central processing unit 30 operating through an audio path controller 40. The CPU 30 also communicates with the cordless and cellular modules 12 and 14, respectively, via universal asynchronous receiver transmitters (UARTs) not shown. The cordless module 12 has an analog audio interface and a digital (PCM) audio interface. The analog audio interface is used for the audio from/to telephone line and digital audio interface is used for the audio from/to cellular line. In the illustrative embodiment, the cellular transceiver module 14 uses an AT-command set for communication with the CPU 30 while the cordless module 12 uses a proprietary command set. Those skilled in the art will appreciate that the invention is not limited to the type of interfaces disclosed herein.

The base station 10 further includes a speech network 60, which serves as a telephone interface, between the audio path controller 40 and the PSTN telephone interface 50. The speech network 60 is a standard telephone line interface such as that sold by Phillips. A codec 70 provides a pulse coded modulation (PCM) interface between the audio path controller 40 and the cordless transceiver module 12. An optional corded telephone 42 is provided and communicates with the audio path controller 40 through a corded telephone interface 44. As another option, a speakerphone 54 is provided with associated amplifier 56, microphone 58 and speaker 62.

Numerous additional components are included in the system 10 such as one or more light emitting diode (LED) indicators 22, a liquid crystal display (LCD) 24, one or more keys 26, an optional backup battery 28, a power management system 32, AC adapter 34, a crystal oscillator 36, a caller ID interface 46, a dial tone generator 48, and a ring detector 60.

FIG. 1B is a block diagram showing a dual mode handset in accordance with an illustrative implementation of the present invention. The handset unit(s) 20 communicates with the base station 10 in a conventional manner via antennas 64 and 66 and a handset cordless telephone module 80. Audio signals from the microphone 68 and to the earpiece and loudspeaker 84 are transferred via a UART (not shown) to a handset CPU 90. The illustrative handset 20 also includes one or more LED indicators 86, an LCD display 88, one or more keys 92, a crystal oscillator 94, a power management circuit 96, battery 97 and a charge control circuit 98.

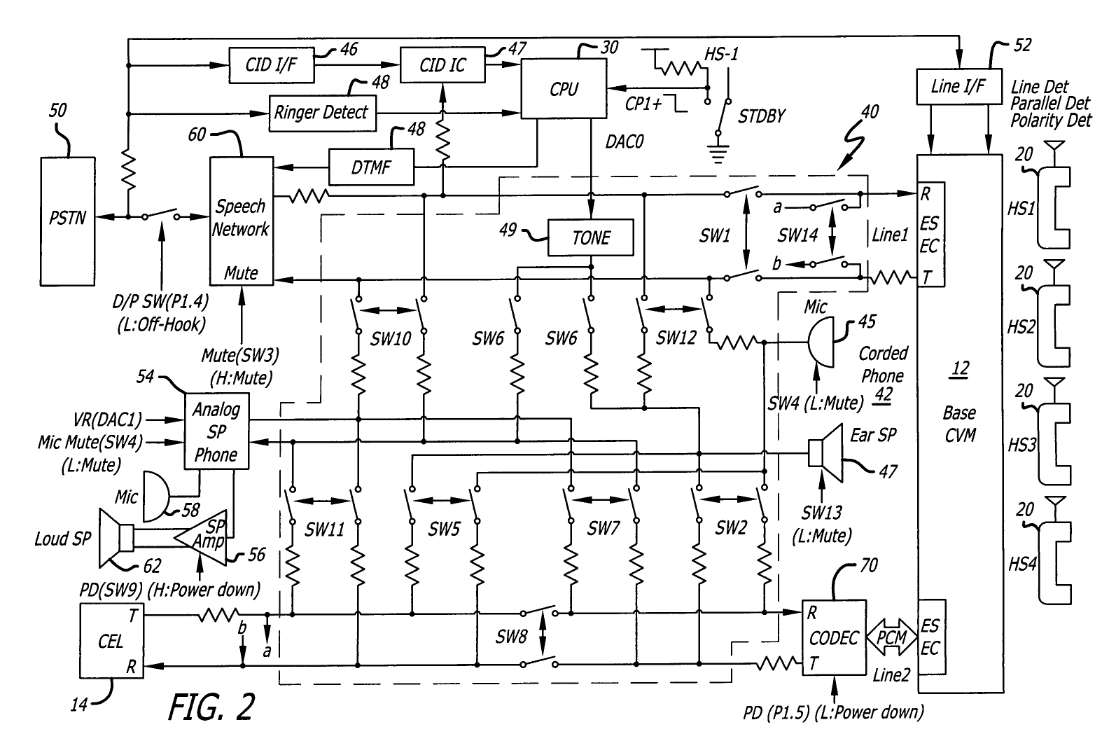

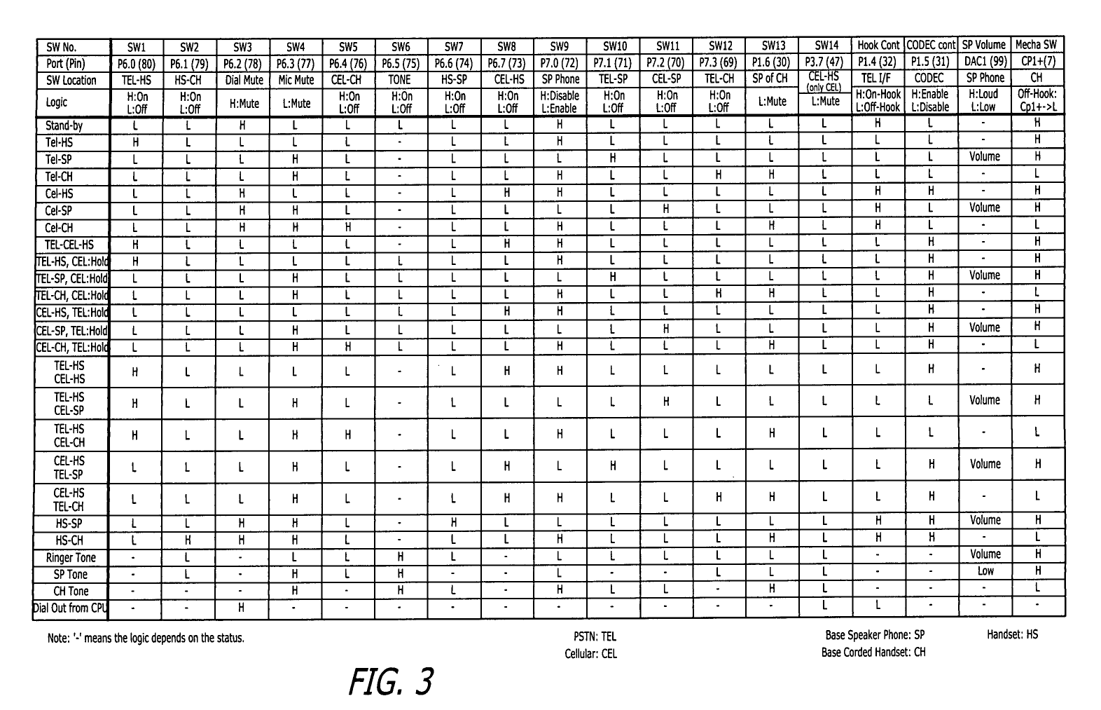

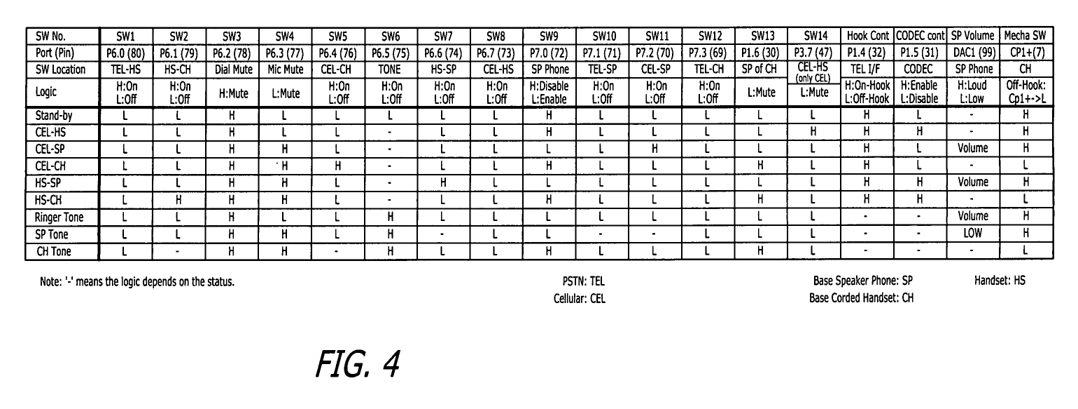

FIG. 2 is a more detailed diagram of the base station of FIG. 1A. As shown in FIG. 2, in the illustrative embodiment, the audio path controller 40 is implemented with a plurality of switches SW1—SW14 and associated resistors. The resistors provide isolation and impedance matching between circuits as well as level matching. The switches are activated by the CPU 30 in accordance with the logic tables shown in FIGS. 3 and 4.

As illustrated in FIG. 2, in a PSTN configuration of the audio path controller 40, the speech network 60 is coupled to the cordless transceiver module 12 and a PSTN interface 50 such as an RJ11 jack. A tone generator 49 is integrated in the CPU 30 and allows the CPU 30 to generate tones.

Activation of a predetermined key 26 on the base unit 10 or 92 on the handset 20 is effective to cause the CPU to change from one configuration and mode to another. For example, activation of a key 26 or 92 may cause the base unit to configure the audio path controller 40 in a cellular mode. In this mode, the base cordless module 12 communicates with the cellular transceiver 14 via the codec 70. In FIG. 2, ‘ES’ refers to an echo suppression function and ‘EC’ refers to an echo cancellation function.

When a call is made by PSTN telephone line, the received audio from TEL line goes to analog input of cordless transceiver module 12 through audio switches controlled by the CPU 30. Also, the transmit audio to TEL line comes from analog output of cordless transceiver module 12. These analog audio signals are converted to digital signals by a codec (not shown) inside of cordless transceiver module 12 followed by an ADPCM block (not shown) which encodes and decodes digital signal to ADPCM format.

When a call is made by cellular network, call processing is performed by the transceiver module. In the illustrative embodiment, as mentioned above, in the illustrative embodiment, the antenna for the cellular network 14 on the base 10 is designed for dual band, e.g., 1900 MHz and 850 MHz. There is a matching component in between the module and the antenna to maximize the gain and efficiency of antenna.

FIG. 3 is a logic table showing switch settings effected by the central processing unit of the base station of FIG. 1A for operation in accordance with an illustrative two-line embodiment of the present invention. In FIG. 3, row 1 shows switch numbers, row 2 shows port (pin) assignments, row three shows switch locations, and row four shows the logic states for each switch. For each operational mode shown in column 1, rows 5-25, the switch settings required to configure the audio path controller 40 are shown in columns 2-15.

FIG. 4 is a logic table showing switch settings effected by the central processing unit of the base station of FIG. 1A for operation in accordance with an alternative cellular only mode of operation. In the illustrative embodiment, the system is a multi-handset system, with 95 physical channels through which signals are frequency hopped to 4 voice handsets.

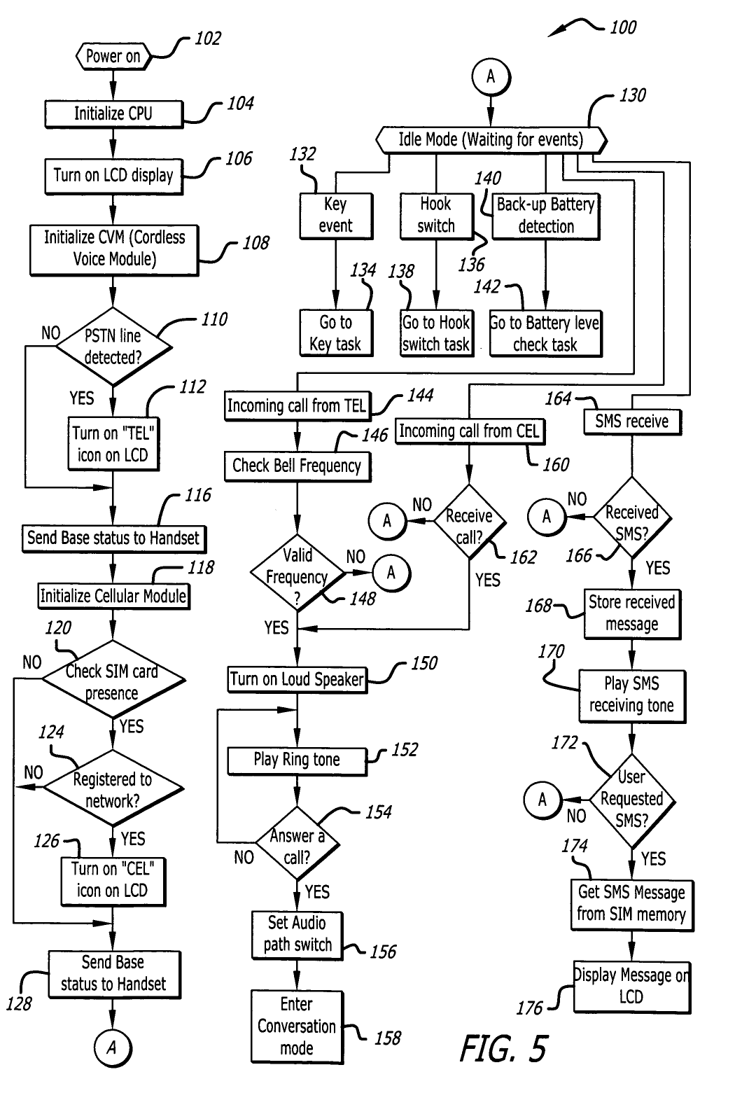

FIG. 5 is a flow diagram of an illustrative embodiment of a method implemented in software and executed by the CPU of the inventive base station in accordance with the present teachings. The method 110 includes a step 102 of powering up the system and a step 104 of initializing the CPU 30. Next, at step 106, the LCD display is turned on and at step 108 the base cordless voice module 12 is activated. At step 110, the system 10 checks for the presence of a PSTN line. If a PSTN line is present, then at step 112 a ‘TEL’ icon is activated on the base and/or handset unit. In any event, at step 116 the base status is sent to the handset.

At step 118 the cellular module is initialized. At step 120 a check is made for the presence of a SIM (Subscriber Identity Module). If a SIM is present, then at step 124 a check is made to determine if it is registered to the network. If it is registered to the network, then at step 126 a ‘CEL’ icon is activated on the LCD display. In any event, at step 128 the base status is sent to the handset. In case of CDMA, there is no SIM check process so CEL icon is activated as soon as it is registered to the network.

At step 130 the system waits for events. If a key is depressed (step 132), then at step 134 the key task is executed. If a hook switch is detected (step 136), then at step 138 the hook switch task is executed. If a backup battery is detected (step 140), then at step 142 a battery level check task is executed.

If an incoming PSTN telephone call is detected (step 144), then at step 146, the bell frequency is detected. If the frequency is determined to be a valid frequency (step 148), then at step 150, the loud speaker is activated. A ring tone is played at step 152 until the call is answered at step 154. When the call is answered, at step 156, the appropriate audio path switch is per FIG. 3 above and ‘conversation mode’ is entered at step 158.

If a cellular call is detected at step 160, the cellular module 14 sends ring indication through UART1 to CPU 30 then the system decides whether to receive the call. If so, it executes steps 150-158. If not, it returns to step 130 and waits.

As illustrated in FIG. 5, the system may also be adapted to receive SMS messages. In this configuration, at step 164, a check is made for an SMS message. At step 166 the cellular module sends SMS receive indication to CPU then the system decides whether to receive the SMS message. If the system opts to receive the message, then the message is stored at step 168 and an appropriate tone is played at step 170. At steps 172-176, on user request, the SMS message is retrieved from SIM memory and displayed.

Thus, the present invention has been described herein with reference to a particular embodiment for a particular application. Those having ordinary skill in the art and access to the present teachings will recognize additional modifications, applications and embodiments within the scope thereof.

It is therefore intended by the appended claims to cover any and all such applications, modifications and embodiments within the scope of the present invention.

Accordingly,

What is claimed is:

1. A communication system comprising:
a first transceiver adapted to communicate with a first network;
a second transceiver adapted to communicate with a second network;
an interface to a third network;
a switching network for routing signals between said first transceiver and said interface in a first mode of operation and for routing signals between said first transceiver and said second transceiver in a second mode of operation; and
a central processing unit for causing said switching network to switch between said first mode and said second mode in response to a control signal.

2. The invention of claim 1 wherein said first network is a cordless telephone network.

3. The invention of claim 2 further including a cordless handset adapted to communicate with said first transceiver.

4. The invention of claim 1 wherein said second network is a wireless cellular network.

5. The invention of claim 1 wherein said third network is a public switched telephone network.

6. A dual mode base station comprising:
first means for routing signals between a cordless transceiver and a public switched telephone network in a first mode of operation and
second means for routing signals between said cordless transceiver and a wireless cellular network in a second mode of operation.

7. A dual mode base station comprising:
a cordless transceiver;
a wireless transceiver;
an interface to a public switched telephone network;
a switching network for routing signals between said cordless transceiver and said interface in a first mode of operation and for routing signals between said cordless transceiver and said wireless transceiver in a second mode of operation; and
a central processing unit for causing said switching network to switch between said first mode and said second mode in response to an input signal.

8. A communication method including the steps of:
providing a first transceiver for communicating with a first network;
providing a second transceiver for communicating with a second network;
providing an interface to a third network; and
routing signals between said first transceiver and said interface in a first mode of operation and routing signals between said first transceiver and said second transceiver in a second mode of operation.

9. The invention of claim 8 wherein said first network is a cordless telephone network.

10. The invention of claim 8 wherein said second network is a wireless cellular network.

11. The invention of claim 8 wherein said third network is a public switched telephone network.

12. A dual mode communication method including the steps of:
routing signals between a cordless transceiver and a public switched telephone network in a first mode of operation via a base station and
routing signals between said cordless transceiver and a wireless cellular network in a second mode of operation via said base station.

13. A dual mode communication system comprising:
a cellular transceiver;
a public switched telephone interface; and
means for communicating via said cellular transceiver and said public switched telephone interface simultaneously.

14. The invention of claim 13 wherein said means for communicating includes means for conferencing said cellular transceiver with said public switch telephone interface.
